(19) United States
(12) Patent Application Publication
(10) Pub. No.: US 2017/0124039 A1
(43) Pub. Date: May 4, 2017

(54) DIGITAL NOTE CREATION

(71) Applicant: Hewlett-Packard Development Company, L.P., Fort Collins, CO (US)

(72) Inventors: Joshua Hailpern, Sunnyvale, CA (US); Shanchan Wu, Palo Alto, CA (US); Rares Vermica, Palo Alto, CA (US); Jerry Liu, Palo Alto, CA (US)

(21) Appl. No.: 15/316,006

(22) PCT Filed: Jun. 2, 2014
(86) PCT No.: PCT/US2014/040491

§ 371 Date: Dec. 2, 2016

(51) Int. Cl. G06F 17/24; G06F 17/21; G06F 3/0484; G06F 17/22

(52) U.S. Cl. CPC G06F 17/241; G06F 17/2235; G06F 17/2247; G06F 17/218; G06F 3/04842; G06F 3/04845

(57) ABSTRACT

In one implementation, a system for digital note creation includes an initiation engine to receive a request to generate a digital note. In addition, the system includes a content engine to determine content from a digital document that is displayed at a time when the request is received, wherein the content from the digital document is extracted to the digital note. In addition, the system includes a data engine to receive data to be included in a digital note that corresponds to the content that is displayed. In addition, the system includes a link engine to create a link between the content that is displayed and the digital note.

### BACKGROUND

Students can make notes and/or highlights on a paper document to emphasize portions of the paper document. In addition, students can make paper note cards that can include brief descriptions or summaries of topics within a textbook. In some other examples, students can use sticky notes to paste other notes into a textbook to give reminders on particular topics.

### BRIEF DESCRIPTION OF THE DRAWINGS

FIG. 1 illustrates a diagram of an example of a system for digital note creation according to the present disclosure.

FIG. 2 illustrates a diagram of an example computing device according to the present disclosure.

FIG. 3 illustrates an example a user interface for digital note creation according to the present disclosure.

FIG. 4 is a flow chart of an example of a method for digital note creation according to the present disclosure.

### DETAILED DESCRIPTION

Marks, notes, and/or highlights can be made on a paper document to emphasize topics within the paper document (e.g., text book, novel, book, transcript, etc.). With digital documents such as electronic books (e-books) can be difficult to make such marks, notes, and/or highlights similar to paper documents. The marks, notes, and/or highlights can be advantageous for users to create relationships and/or connections between materials within the digital document.

Digital note creation can include a user interface that allows for creation of a number of digital notes that can correspond to particular portions of a digital document. As used herein, a digital note includes text, images, and/or videos that can be utilized to aid in an understanding of the digital document. For example, a digital note can be a text description of a portion of the digital document. As used herein, a digital document is a digital representation of a document that includes text, images, executable links, interactive elements, and/or videos.

Digital note creation can include creating a digital note that corresponds to a selected portion of the digital document. In some embodiments, the selected portion can include a page of the digital document that is currently being viewed by a user. In other embodiments, the selected portion can include selected text interactive computer programs such as Javascript or Flash, and/or multimedia (e.g., images, video, audios) of the digital document. Creating a digital note that corresponds to a selected portion of the digital document can include linking the digital note to the selected portion of the digital document. As used herein, linking the digital note to the selected portion includes creating a link that when selected can display the selected portion of the digital document. That is, selecting the link can display the selected portion of the text and the digital note that corresponds to the selected portion.

In some embodiments, digital note creation can include uploading an image of a paper document and creating a digital note with the uploaded paper document. The digital notes that are created can be categorized and/or organized. Categorizing the digital notes can be based on assigned tags from a user and/or based on meta-data from the created digital note. Categorizing the digital notes can also include indexing the digital notes to enable searching the digital notes based on a number of factors including, but not limited to assigned tags and/or meta-data.

Digital note creation as described herein can provide a user with capabilities to make notes that correspond, to a digital document in a similar manner to making notes on a paper document. Digital note creation as described herein can be advantageous over previous methods of attaching notes to a digital document by separating the digital document from the digital notes to allow a user to focus on reading the digital document without having notes directly on the digital document. In addition, digital note creation as described herein can enable easier digital note identification and easier identification of the corresponding content of the digital document, as compared to other methods, by creating a link between the digital note that is created and the corresponding content of the digital document.

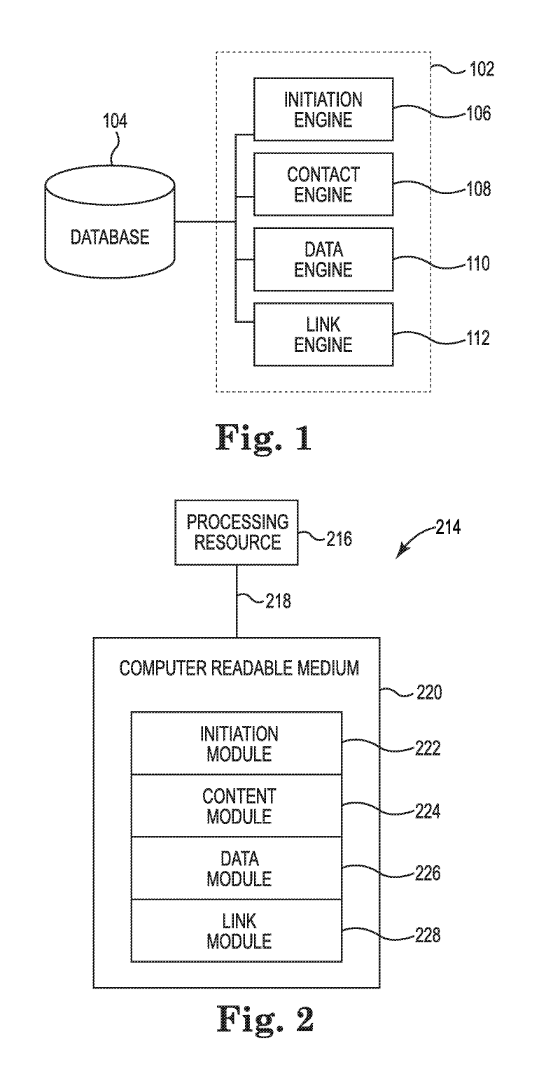

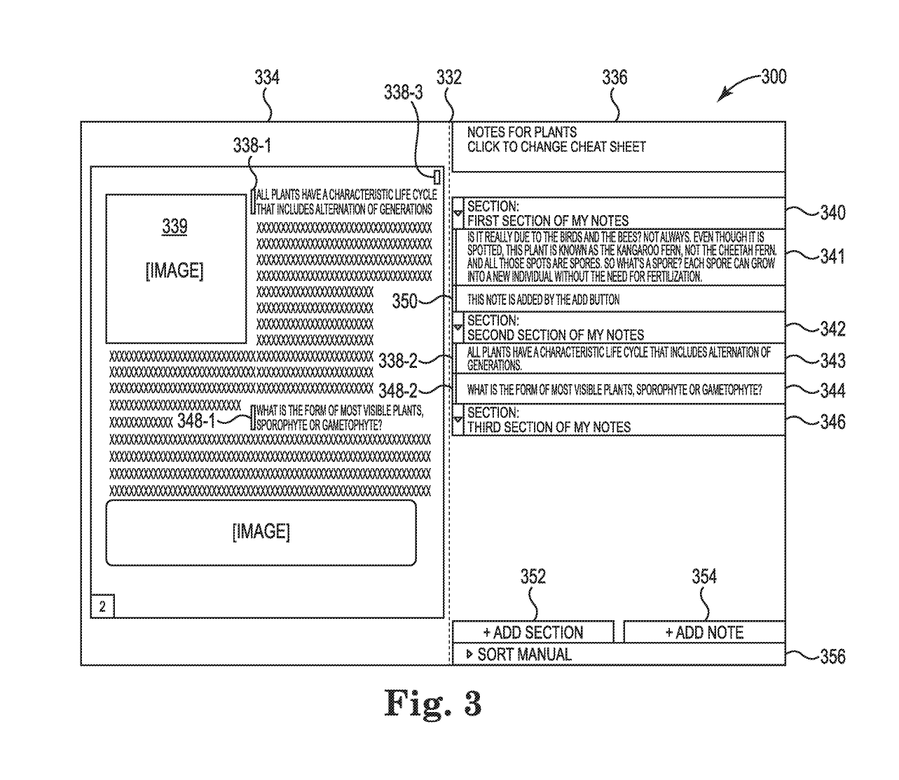

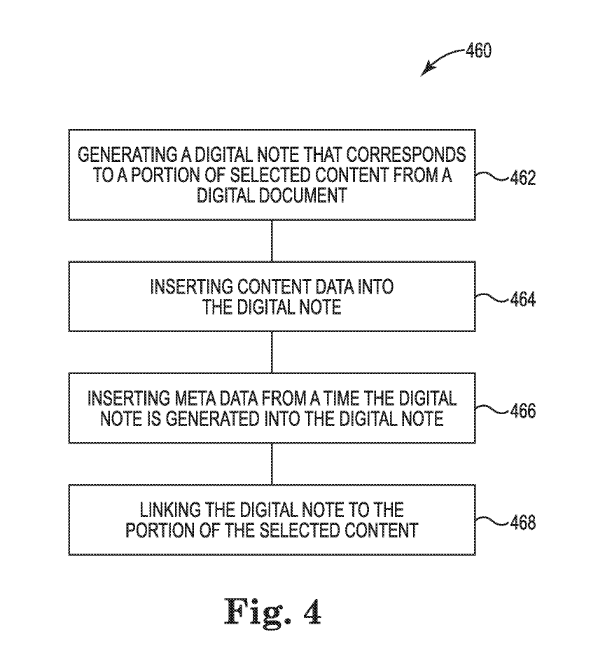

FIG. 1 illustrates a diagram of an example of a system for digital note creation according to the present disclosure. The system can include a database 104, a digital note creation system 102, and/or a number of engines. The digital note creation system 102 can be in communication with the database 104 via a communication link, and can include the number of engines including, but not limited to: an initiation engine 106, a content engine 108, a data engine 110, and/or a link engine 112. The digital note creation system 102 can include additional or fewer engines that are illustrated to perform the various functions as will be described in further detail in connection with FIG. 3 and FIG. 4.

The number of engines (e.g., initiation engine 106, content engine 108, data engine 110, link engine 112, etc.) can include a combination of hardware and programming, but at least hardware, configured to perform a number of functions described herein (e.g., receive a request to generate a note, determine content from a digital document that is displayed at a time when the request is received, receive data to be included in a digital note that corresponds to the content that is displayed, create a link between the content that is displayed and the digital note, etc.). The programming can include program instructions (e.g., software, firmware, etc.) stored in a memory resource (e.g., computer readable medium, machine readable medium, etc.) as well as hard-wired program (e.g., logic).

The initiation engine 106 can include hardware and/or a combination of hardware and programming, but at least hardware, to receive a request to generate a note. The request to generate a note can be initiated by a user and sent to the initiation engine 106. The request can include a digital note type, which can include a specification of what is intended to be inserted and/or included in the digital note. For example, the digital note type can include, but is not limited to: a text note, an image note, a scanned paper document note, a video note, an audio note, among other digital note types.

The content engine 108 can include hardware and/or a combination of hardware and programming, but at least hardware, to determine content (e.g., text data from the digital document, image data from the digital document, video data of the digital document, an executable link from the digital document, and an interactive element from the digital document, etc.) from a digital document that is displayed at a time when the request is received, wherein content from the digital document is extracted to the digital note. As used herein, content from the digital document includes text, images, videos, links, and/or graphs within the digital document.

The content from the digital document can vary based on the topics covered by the digital document. For example, the content from a digital document relating to biology can be different than the content from a digital document relating to philosophy. The content data can be extracted to the digital note. That is, the content data can be sent from the digital document that is displayed in a first user interface to the digital note that is displayed in a second user interface. In some embodiments, the digital document is separated from the digital notes that are generated. As described further herein, the digital document can be displayed in a first user interface of a first application (e.g., computing program, etc.). For example, the digital document can be displayed in a user interface of an e-reader application. In addition, the digital note can be displayed in a second user interface of a second application. For example, the digital note can be displayed in a user interface of a digital note generator application that is separate from the e-reader application. Thus, extracting content data can include sending content data from a first application to a second application when a request to generate a digital note is received.

In some embodiments, the determined content can include content that is selected by a user. While content is selected by a user can be selected and while the content is selected a request for creating a digital note can be received. In this embodiment, the digital note can correspond to the selected content.

The data engine 110 can include hardware and/or a combination of hardware and programming, but at least hardware, to receive data to be included in a digital note that corresponds to the content that is displayed. In some embodiments, the data engine 110 can determine meta-data associated with the digital document at the time when the request is received. The meta-data can include, but is not limited to: a time, a date, and/or a geographical location at the time when the request is received. The received data can be utilized in categorizing a number of generated digital notes. In addition, the received data can be utilized to index the number of generated digital notes and enable searching of the number of generated digital notes utilizing the data. For example, a search for a particular digital note can include requesting a digital note generated at a particular location, generated at a particular time, and/or generated on a particular date.

In some embodiments, the data can include data that is received from an ambient consumption device (e.g., Google Glass, desk camera, etc.) monitoring a user drafting a paper document. As used herein, an ambient consumption device includes a device that is capable of monitoring interactions of a user drafting notes on a document not associated with the system.

The link engine 112 can include hardware and/or a combination of hardware and programming, but at least hardware, to create a link between the content that is displayed and the digital note. The link engine 112 can be configured to create a link between the content, the digital note, source material of the digital document, and/or a page layout of the digital document at the time when the request is received. For example, selecting (e.g., selected by a user) the created link can display the content, the digital note, the source material, and/or the page layout of the digital document at the time the request is received.

The link engine 112 can create a link that can be selected from a plurality of locations. For example, the link engine 112 can create a link near the content in the digital note, in the digital note, and/or other locations of a user interface. In some embodiments the link can be embedded in a tag that is attached to the digital document at a position to indicate the corresponding content. In some embodiments, the tag can be a colored tag that indicates a categorization of the content and/or categorization of the digital note.

FIG. 2 illustrates a diagram of an example computing device 214 according to the present disclosure. The computing device 214 can utilize software (e.g., program instructions), hardware, firmware, and/or logic to perform a number of functions described herein.

The computing device 214 can include a combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing program instructions stored by a memory resource 220.

Processing resource 216 may be implemented in a single device or distributed across multiple devices. The program instructions (e.g., computer and/or machine readable instructions (CRI/MRI)) can include instructions stored on the memory resource 220 and executable by the processing resource 216 to implement a desired function (e.g., determine selected content from a digital document, receive a request to generate a digital note that corresponds to the selected content, wherein the selected content from the digital document is extracted to the digital note, receive data to be included in the digital note, link the digital note to the selected content, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

As shown in the example of FIG. 2, the computing device 214 can include a number of modules (e.g., initiation module 222, content module 224, data module 226, link module 228). As used herein, the term module is intended to include program instructions that when executed by the processing resource 216 can perform a number of functions. The number of modules (e.g., initiation module 222, content module 224, data module 226, link module 228) can be combined with other modules or be sub-modules of other modules. The number of modules can be stored in a single memory resource. For example, the content module 224 and the data module 226 can be sub-modules and/or contained within the same computing device. In another example, the number of modules can comprise individual modules at separate and distinct locations (e.g., CRM, etc.).

Each of the number of modules can include instructions that when executed by the processing resource 216 can function as a corresponding engine as described herein. For example, the initiation model module 222 can include instructions that when executed by the processing resource 216 can function as the initiation engine 106. In another example, the content module 224 can include instructions that when executed by the processing resource 216 can function as the content engine 108. In another example, the data module 226 can include instructions that when executed by the processing resource 216 can function as the data engine 110. In another example, the link module 228 can include instructions that when executed by the processing resource 216 can function as the link engine 112.

FIG. 3 illustrates an example user interface 300 for digital note creation according to the present disclosure. The user interface 300 can display a digital document 334 on a first side (e.g., left side of line 332) and digital note generator 336 on a second side (e.g., right side of line 332). The digital document 334 can be an electronic document of a book such as an e-book. The line 332 can represent a separation between the digital document 334 and the digital note generator 336. The separation line 332 can include a separation between a first application (e.g., digital note 334, e-reader application, etc.) and a second application (e.g., digital note generator 336, digital note application, etc.).

Separating the digital note generator 336 from the digital document 334 can be advantageous for a number of different embodiments. In some embodiments, the digital note generator 336 can, be utilized to generate digital notes for multiple different digital documents such as digital document 334. For example, a student user can have multiple digital documents for a particular subject and may want to utilize the digital note generator 336 to make notes for each of the multiple digital documents. In this example, notes from a first digital document and notes from a second digital document can each be utilized to create digital notes within the same digital note generator 336.

By separating the digital note generator 336 and the digital documents 334, a user can focus on reading a digital document without additional marks that can distract the reader. In addition, by separating the digital note generator 336 and the digital documents 334, a user can include all notes from multiple digital documents into a single digital note generator 336 user interface and can utilize the links that are generated to easily display portions of each of the multiple digital documents by selecting the link. For example, a student user can review generated notes utilizing the digital note generator 336 and select tags with an embedded link and a corresponding portion of a corresponding digital document can be displayed. In this example, the student user can select a different tag with an embedded link and a different corresponding digital document can be displayed. Enabling a user to select a link to a corresponding portion of a number of different digital documents can be advantageous over previous methods.

In some embodiments, the electronic document can include a digital version of a textbook (e.g., education textbook in a digital format, e-textbook, etc.). As described herein, a user can utilize the digital document 334 to learn and/or retain information from the digital document 334. For example, the user can be a student at an educational institution that is utilizing the digital document 334 to learn a topic that is described in the digital document 334. The generated digital notes can be advantageous for users to create relationships and/or connections between content within the digital document.

The user interface 300 can include, the digital note generator 336 to generate digital notes that corresponds to the digital document 334. Generating a digital note can include generating a digital note that includes content that is displayed at a time when the request to generate the digital note is received. For example, a user can select an add note button 354 when page 2 of the digital document 334 is displayed. When the add note button 354 is selected a tag 338-3 can be added to the digital document 334 and a corresponding digital note 341 can be added under a selected section 340. The selected section 340 can include a portion of data (e.g., text, video, image, etc.) that is highlighted by a user. In some embodiments, a section can be added to the digital note generator 336 by selecting the add section button 352. The number of sections can be used to categorize the number of generated digital notes. That is, a user can separate a plurality of notes based a preference of a user. For example, a user can separate a plurality of notes that are generated based on topics within the digital document 334 among other preferences of the user (e.g., based on test dates, based on table of contents, etc.).

Generating a digital note can include generating a digital note that corresponds to a portion of selected content from the digital document 334. The portion of selected content can include a particular paragraph of the digital document 334. For example, a portion 338-1 can be selected from the digital document 334 and a note 343 can be generated in the digital note generator 336. The portion of selected content can be selected (e.g., highlighted, etc.) and the add note button 354 can be selected to add the selected portion to a selected section 342. The portion of selected content can also be selected and “dragged” into a particular section to add a digital note to the digital note generator 354. As described herein, the selected portion from the digital document 334 can be added and organized in the digital note generator 336 by adding a number of sections (e.g., section 340, section 342, section 346, etc.) and generating notes corresponding to the selected portion into the number of sections.

The selected portion can be tagged to identify the selected portion and create a link between the selected portion and a corresponding note. For example, a tag 348-1 can be inserted next to a portion of text from the digital document 334 and correspond to a tag 348-2 next to a note 344. A link can be embedded in the tag 348-1 and in the tag 348-2 so that selection of the tag 348-1 can display note 344 in the digital note generator 336 that corresponds to the text next to link 348-1. In addition, a link can be embedded in the tag 348-2 so that selection of tag 348-2 can display the selected portion corresponding to link 348-1 within the digital document 334. Creating a link between digital notes within the digital note generator 336 and selected portions of the digital document 334 can enable a user to switch a display between portions of the digital document 334 and portions of the generated notes of the digital note generator 336.

Creating a link by embedding the link in a tag can include creating a link between the content in the digital document 334, the digital note corresponding to the content, source material (e.g., meta-data) of the digital document 334, and a page layout of the digital document 334 at the time when the request for a digital note is received. Linking elements of the digital document 334 and the generated digital notes can enable displaying desired portions of the digital documents 334 and desired digital notes while reviewing and utilizing the digital document.

The portion of the digital document 334 that is selected when generating a note in the digital note generator 336 can be altered in the digital note generator 336. For example, the selected text can be added as a note in the digital note generator 336, and the text can be edited and/or altered by adding or deleting text. In another example, the selected text can be added as a note in the digital note generator 336 and the text can be edited and/or altered by adding or deleting images. In this example, the selected portion can include a portion of text next to tag 338-1 and image 339.

The image 339 can be added under section 342 next to the text portion of note 343. As described herein, the image 339 can be altered and/or deleted to emphasize the corresponding text portion and image 339. In these examples, the tag 338-1 can be altered to include the image 339. That is, the tag 338-1 can be positioned next to the text portion and the image 339.

The number of tags can be color-coded to identify and categorize the number of generated notes in the note generator 336. For example, tag 338-1 and corresponding tag 338-2 can be color coded to identify that tag 338-1 corresponds to tag 338-2. Tag 338-1 and corresponding tag 338-2 can be assigned a color red to identify that tag 338-1 and corresponding tag 338-2 are linked via an embedded link in tag 338-1 and tag 338-2 in some examples.

When a digital note is generated in the digital note generator 336, data can be collected that corresponds to the generated digital note. The data can include meta-data that corresponds to the generated digital note. In some embodiments, the data can include meta-data that includes a date of receiving the request to generate the digital note, a time of receiving the request to generate the digital note, and/or a location of where the request for a digital note was requested. For example, meta-data for a particular digital note can include a date that the digital note is requested. In addition, the meta-data can include a particular time that the digital note is requested. Furthermore, the meta-data can include a particular location of a user and/or a particular location of a device when the digital note is requested. For example, the meta-data for note 343 can include that the note 343 was requested on May 25, 2014 at 6:00 PM Central Standard Time (CST) at a particular Starbucks Coffee location.

As described herein, the number of digital notes can be categorized utilizing a number of categorization techniques via a computing system. In addition, the number of digital notes can be categorized utilizing the meta-data. That is, the number of digital notes can be categorized by the computing system based on the date and/or the date and time that the number of notes were generated. Furthermore, the number of digital notes can be categorized based on the location where the number of digital notes were generated. In some embodiments, a combination of the meta-data can be utilized to categorize the number of digital notes.

The number of generated digital notes can be categorized utilizing a number of manual methods implemented via a computing system utilizing the user interface 300. For example, the number of generated digital notes can be sorted utilizing, a sort manual button 356 of the user interface 300 to sort the number of digital notes based on the meta-data and/or categorization implemented by a user as described herein. For example, the sort manual button 356 can be selected to display a number of options for categorizing the number of digital notes. In some embodiments, the number of options for categorizing the number of digital notes can include a date generated and/or edited categorization, a time categorization, a location categorization, and/or additional categorization options. The number of options for categorization can be executed by the computing system as described herein.

The number of generated digital notes can be searched utilizing the data and/or meta-data associated with each of the number of generated digital notes via a computing system utilizing the user interface 300. For example, a search button (not shown) can be selected via the user interface 300 to insert search criteria relating to the data and/or meta-data associated with each of the number of generated digital notes. The search criteria can include a date and/or time associated with the number of generated digital notes. The search criteria can also include a location where a portion of the number of generated digital notes were requested. For example, a can user insert search criteria into the user interface 300 that includes a location of Starbucks Coffee. In this example, the digital note generator 336 can display digital notes that were generated when a computing device is located at a Starbucks Coffee. Searching the number of generated digital notes can enable a use to easily search for digital notes that were generated at a particular location.

This type of searching can be advantageous for users that can remember making a digital note at a particular date, time, and/or location that is desired to be displayed at a later time and/or different location. This type of searching can also provide a more robust type of search. That is, a search engine utilized to search the number of generated digital notes can utilize more data to search and retrieve particular portions of the number of generated digital notes compared to previous methods. For example, the search engine can utilize the meta-data and/or categorization data from a user associated with each of the number of generated digital notes to provide a particular portion of the generated digital notes.

In some embodiments, the digital note can include data that is received from an ambient consumption device (e.g., Google Glass, desk camera, etc.) monitoring a user's actions while drafting a paper document. As used herein, an ambient consumption device includes a device that is capable of monitoring interactions of a user drafting notes on a document not associated with the system. Data that is received from an ambient consumption device can be uploaded to the digital note generator 336 and a number of digital notes can be created utilizing the data from the ambient consumption device via a computing system utilizing the user interface 300. Digital notes that are generated to include the data that is received from an ambient consumption can be linked to particular portions of the digital document 334. For example, data from the ambient consumption device can correspond to a particular chapter of the digital document. In this example, a tag can be utilized to link, the note with the data from the ambient consumption device to the particular chapter of the digital document.

The data from the ambient consumption device can include video and/or audio data of a user interacting with the digital document 334. For example, the data from the ambient consumption device can include audio and/or video from a lecture associated with the digital document 334 and the audio and/or video can include a user making notes in real time during the lecture.

In some embodiments, digital note creation can include uploading a paper document and creating a digital note with the uploaded paper document via a computing system utilizing the user interface 300. Uploading a paper document can include uploading paper documents that are related to the digital document 334. For example, paper documents that are received from a teacher or lecturer on a topic can be received and uploaded to the digital note generator 336. This allows digital notes to be generated that include various types of resources in a single location (e.g., digital note generator 336, database, etc.). In addition, the uploaded paper documents can be categorized and/or organized as described herein in reference to generated digital notes via a computing system utilizing the user interface 300. In some embodiments, the paper documents can include paper documents of notes created by a user utilizing the ambient consumption device as described herein.

In some embodiments, the digital note generator 336 can digitally watermark the generated digital notes with a portion of received data via a computing system utilizing the user interface 300. Creating a digital watermark can be utilized in a variety of areas to create a unique mark to identify a particular set of generated digital notes with a particular user. In some embodiments, it can be beneficial to create a unique identifier so that the digital notes that are generated can be submitted for review. For example, the digital watermark can be utilized to identify a particular student at an educational institution when an instructor requests notes from the students utilizing the digital document 334.

The digital watermark can include a combination of data to ensure that the watermark is unique and that the number of digital notes were generated by a particular user. For example, the meta-data that is received when the digital notes were generated can be utilized when creating the digital watermark. In some embodiments, the date, time, and/or location can be utilized in the digital watermark to ensure that the generated digital notes were generated by the particular user. In some embodiments, the digital watermark can be a watermark on a printed version of the number of digital notes. For example, a particular student can print the number of digital notes and a watermark or header can be printed on the number of digital notes.

In addition, the digital note generator 336 can embed a machine readable optical label (e.g., barcode, QR code, etc.) that be utilized similarly to selecting the link, as described herein. For example, a machine readable optical label can be digitally embedded within each generated note. In this example, the machine readable optical label can be scanned and corresponding information relating to the generated note can be displayed. In some embodiments, the number of digital notes can be printed with the machine readable optical label. In these embodiments, each of the digital notes can include a machine readable optical label that when scanned by the device can display a corresponding portion of the digital document 334.

By embedding a machine readable optical label via a computing system utilizing the user interface 300, the generated digital notes can be printed out and the machine readable optical label can be utilized to navigate the digital document 334 while reviewing the printed digital notes. For example, the digital notes can be printed to a paper document via a computing system utilizing the user interface 300. In this example, a machine readable optical label can be embedded and printed to each of the number of generated notes. Furthermore, in this example, the device for displaying the digital document 334 can be utilized to scan the machine readable optical label and a corresponding portion of the digital document can be displayed. As described herein, the corresponding portion of the digital document 334 can be displayed in a format that is the same and/or similar to the format of the digital document 334 when the user originally generated the corresponding digital note.

The digital note systems and methods as described herein can enable a user to more easily generate digital notes that correspond to particular portions of a digital document. In addition, the digital note systems and methods can enable a user to categorize and search the number of generated digital notes based on data that is input by a user and/or meta-data associated with each of the generated digital notes. Thus, the digital note systems and methods as described herein can provide a user interface 300 that enables a user to easily associate generated digital notes to corresponding portions of the digital document that is more similar to paper note generation compared to previous systems and methods of digital note generation.

FIG. 4 is a flow chart of an example of a method 460 for digital note creation according to the present disclosure. As described herein, the method 460 can provide a user interface that is configured to generate a number of digital notes that correspond to portions of a digital document. Each of the digital notes can include content data (e.g., text, images, videos, etc.) that can be utilized to emphasize portions of the digital document via a computing system as described herein. In addition, each of the digital notes can include a tag with an embedded link to display the note and/or the portion of the digital document upon selection of the tag. Method 460 can be performed, for example, using engines and/or modules as discussed in FIG. 1 and FIG. 2. Method 460 can also be implemented via a computing system utilizing the user interface 300 as referenced in FIG. 3.

At 462, the method 460 can include generating a digital note that corresponds to a portion of selected content from a digital document, wherein the digital note is separated from the digital document. Generating a digital note that corresponds to a portion of selected content can include selecting the portion of content, via a computing system utilizing a user interface, from the digital document and either “dragging” the selected content via a computing system utilizing a user interface to a digital note generator or selecting the portion of content from the digital document and selecting an add note button as described herein. The portion of selected content can include text data, image data, video data, among other data within a digital document. In some embodiments, the portion of selected content can be a page of a digital document that is currently being viewed when an add note button is selected. As described herein, the selected content can include a digital image of a paper document that is uploaded to a digital note generator via a computing system utilizing a user interface as described herein.

In some embodiments, the selected content from the digital document can include suggested content, wherein the suggested content is based on existing content of the digital note and/or existing content of other digital notes within a section. For example, a digital note can include text that describes a particular image within the digital document. in this example, a digital note generator (e.g., digital note generator 336, etc.) can provide a suggestion to the user to add the particular image to an existing digital note and/or to a newly added digital note. The suggestion can include a text pop-up that describes the suggestion. In some embodiments, a watermark type image can be displayed to show a user a visual representation of the suggested digital note.

Separated from the digital document can include having a first application that can display and navigate the digital document and having a second application that can generate a number of digital notes. As described further herein, some embodiments include a digital, document application that is separate and/or distinct from a digital note generator application. This embodiment enables digital notes to be generated and stored for a plurality of different digital documents. That is, the digital note generator application can be utilized to generate digital notes from an electronic textbook (e-textbook), an electronic document received in an email, and/or an electronic novel (e-book). This, can enable a user to utilize multiple digital resources by generating digital notes for each of the multiple digital resources and creating links to each of the multiple digital resources.

In some embodiments, as described herein, the link can display a corresponding digital document with a particular orientation. For example, the link can display a corresponding digital document with a number of visual settings that were configured when the digital note was requested. In this example, the number of visual settings can include, but are not limited to zoom settings, color settings, document orientation settings, font settings, format settings, among other visual settings that can be applied to digital documents.

At 464, the method 460 can include inserting content data into the digital note via a computing system. Inserting content data into the digital note can include inserting a section of the digital document into the digital note, wherein the section is not included in the portion of the selected content. Inserting content data can include altering a text and/or other content that is selected in a digital note generator. For example, an equation within the digital document can be selected, and text to describe each variable of the equation can be added to the digital note via the digital note generator. In the examples of adding/inserting content data into the digital note, the inserted content data may not alter or change the content data within the digital document. That is, a tag can be utilized to identify a corresponding location of the note without altering the content of the digital document. This can enable a user utilizing a user interface to more easily read the digital document without distracting notes within the digital document itself.

At 466, the method 460 can include inserting meta-data via a computing system from a time the digital note is generated into the digital note. The meta-data from the time the digital note is generated can include meta-data of a digital document and/or digital note that is collected at the time when the digital note is requested. Thus, inserting meta-data from a time the digital note is generated can include inserting data that relates to when and/or where the digital note was generated. For example, a date, time, and/or location can be inserted from the meta-data into the digital note. The, meta-data may not be displayed in some embodiments, but the meta-data that is inserted into the digital note can be utilized to categorize and/or search for digital notes.

At 468, the method 460 can include linking the digital note to the portion of the selected content via a computing system. Linking the digital note to the portion of the selected content can include inserting a tag next to the selected content of the digital document and inserting a corresponding tag next to the digital note that corresponds to the selected content. The tag can include a color coded identification as well as link that can be selected to display the corresponding tagged item. That is, a tag next to a digital note can be selected, and the corresponding selected content can be displayed within the digital document. Similarly, a tag next to selected content can be selected to display a corresponding generated digital note. The linking of the digital note and the corresponding portion of content within the digital document can enable a user to review different portions of content from different areas of a digital document without having to view undesired portions between the different areas of the digital document.

As used herein, “logic” is an alternative or additional processing resource to perform a particular action and/or function, etc., described herein which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system for digital note creation, comprising:
an initiation engine to receive a request to generate a digital note;
a content engine to determine content from a digital document that is displayed at a time when the request is received, wherein the content from the digital document is extracted to the digital note;
a data engine to receive data to be included in a digital note that corresponds to the content that is displayed; and
a link engine to create a link between the content that is displayed and the digital note.

2. The system of c aim wherein the content includes at least one of: text data from the digital document, image data from the digital document, video data of the digital document, an executable link from the digital document, and an interactive element from the digital document.

3. The system of claim 2, wherein the link engine is configured to create a link between the content, the digital note, source material of the digital document, and a page layout of the digital document at the time when the request is received.

4. The system of claim 1, wherein the data engine is configured to determine meta-data associated with the digital document at the time when the request is received.

5. The system of claim 4, wherein the meta-data includes a time, a date, and a geographical location at the time when the request is received.

6. The system of claim 1, wherein the data engine is configured to receive an image of a paper document uploaded to the system.

7. The system of claim 1, wherein the data engine is configured to receive data from an ambient consumption device monitoring a user drafting a paper document.

8. A non-transitory computer readable medium storing instructions executable by a processing resource to:
determine selected content from a digital document;
receive a request to generate a digital note that corresponds to the selected content, wherein the selected content from the digital document is extracted to the digital note;
receive data to be included in the digital note; and
link the digital note to the selected content.

9. The medium of claim 8, comprising instructions executable to categorize the digital note by attaching a tag to the digital note.

10. The medium of claim 8, comprising instructions executable to digitally watermark the digital note with a portion of the received data.

11. The medium of claim 8, comprising instructions executable to index the digital note into a database of a plurality of digital notes, wherein the database can be categorized based on the received data included in the digital note.

12. A method for data reconstruction, comprising:
generating a digital note that corresponds to a portion of selected content from a digital document, wherein the digital note is separated from the digital document;
inserting content data into the digital note;
inserting meta-data from a time the digital note is generated into the digital note; and
linking the digital note to the portion of the selected content.

13. The method of claim 12, wherein inserting content into the digital note includes inserting a section of the digital document into the digital note, wherein he section is not included in the portion of the selected content.

14. The method of claim 12, wherein separating the digital note from the digital document includes providing a first user interface for the digital document and a second user interface for the digital note.

15. The method of claim 14, comprising categorizing the digital note into a database based on the meta-data.
